(19) United States
(12) Patent Application Publication
(10) Pub. No.: US 2008/0299838 A1
(43) Pub. Date: Dec. 4, 2008

(54) Power connectors for mating with bus bars

(76) Inventor: Christoph Kopp, Matzen (AT)

Correspondence Address: HARNESS, DICKEY, & PIERCE, P.L.C, 7700 Bonhomme, Suite 400, ST. LOUIS, MO, 63105, US

(21) Appl. No.: 11/809,243

(22) Filed: May 31, 2007

(51) Int. Cl. H01R 4/48

(52) U.S. Cl. 439/786

(57) ABSTRACT

A power connector for mating with a bus bar includes a conductive support structure defining at least a first slot, an electrical contact positioned within the first slot, and a biasing pin positioned within the first slot and engaging the electrical contact. The biasing pin biases at least a first portion of the electrical contact against the conductive support structure to maintain electrical conductivity between the conductive support structure and the electrical contact. At least a second portion of the electrical contact engages a bus bar when the bus bar is received in the first slot.

### FIELD

The present disclosure relates generally to power connectors, and particularly to high current power connectors for mating with bus bars.

### BACKGROUND

The statements in this section merely provide background information related to the present disclosure and may not constitute prior art.

A wide variety of power connectors are known in the art for mating with a bus bar. These power connectors commonly include a plastic housing enclosing one or more contact members. The contact members form a pressure fit when a bus bar is inserted into the connector. The contact members are typically soldered or screwed to a backplane, creating an electrical path between the bus bar and the backplane.

### SUMMARY

According to one aspect of this disclosure, a power connector for mating with a bus bar includes a conductive support structure defining at least a first slot, an electrical contact positioned within the first slot, and a biasing pin positioned within the first slot and engaging the electrical contact. The biasing pin biases at least a first portion of the electrical contact against the conductive support structure to maintain electrical conductivity between the conductive support structure and the electrical contact. At least a second portion of the electrical contact engages a bus bar when the bus bar is received in the first slot.

According to another aspect of this disclosure, a high current power connector for mating with a first and a second bus bar includes a first conductive support structure defining a first slot, a first electrical contact positioned within the first slot, a first biasing pin positioned within the first slot and engaging the first electrical contact, a second conductive support structure defining a second slot, a second electrical contact positioned within the second slot, a second biasing pin positioned within the second slot and engaging the second electrical contact, and an electrically insulative material covering an external portion of the first conductive support structure and the second conductive support structure. The first electrical contact engages a bus bar when the bus bar is received in the first slot. The first biasing pin biases at least a portion of the first electrical contact against the conductive support structure to maintain electrical conductivity between the first conductive support structure and the first electrical contact. The second electrical contact engages a bus bar when the bus bar is received in the second slot. The second biasing pin biases at least a portion of the second electrical contact against the conductive support structure to maintain electrical conductivity between the second conductive support structure and the second electrical contact.

According to yet another aspect of this disclosure, a high current power connector assembly for providing power from a power source to a load includes a bus bar and a high current power connector. The high current power connector includes a conductive support structure defining at least a first slot, an electrical contact positioned within the first slot, and a biasing pin positioned within the first slot. At least a first portion of the electrical contact releasably engages the bus bar in the first slot. The biasing pin biases at least a second portion of the electrical contact against the conductive support structure to maintain electrical conductivity between the conductive support structure and the electrical contact.

According to another aspect of this disclosure, a method is provided for of using a power connector that includes a conductive support structure defining at least a first slot, an electrical contact positioned within the first slot, and a biasing pin positioned within the first slot. The biasing pin biases at least a first portion of the electrical contact against the conductive support structure. The method includes engaging a bus bar to the power connector by inserting the bus bar in the first slot of the conductive support structure. The bus bar deforms at least a second portion of the electrical contact.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a top view of a power connector according to one embodiment of the present disclosure.

FIG. 2 is a top view of a power connector having a rectangular biasing pin according to another embodiment of the present disclosure.

FIG. 3 is a top view of a power connector having an ovular biasing pin according to another example of the present disclosure.

FIG. 4 is a top view of a power connector having a c-lock spring pin.

FIG. 5 is an exploded view of a power connector coupled to an internal bus bar according to one example of the present disclosure.

FIG. 6A is perspective view of a power connector including multiple conductive support structures.

FIG. 6B is a cross-sectional view of the power connector of FIG. 6 along Axis A-A of FIG. 6A.

### DETAILED DESCRIPTION

The following description is merely exemplary in nature and is not intended to limit the present disclosure, application, or uses.

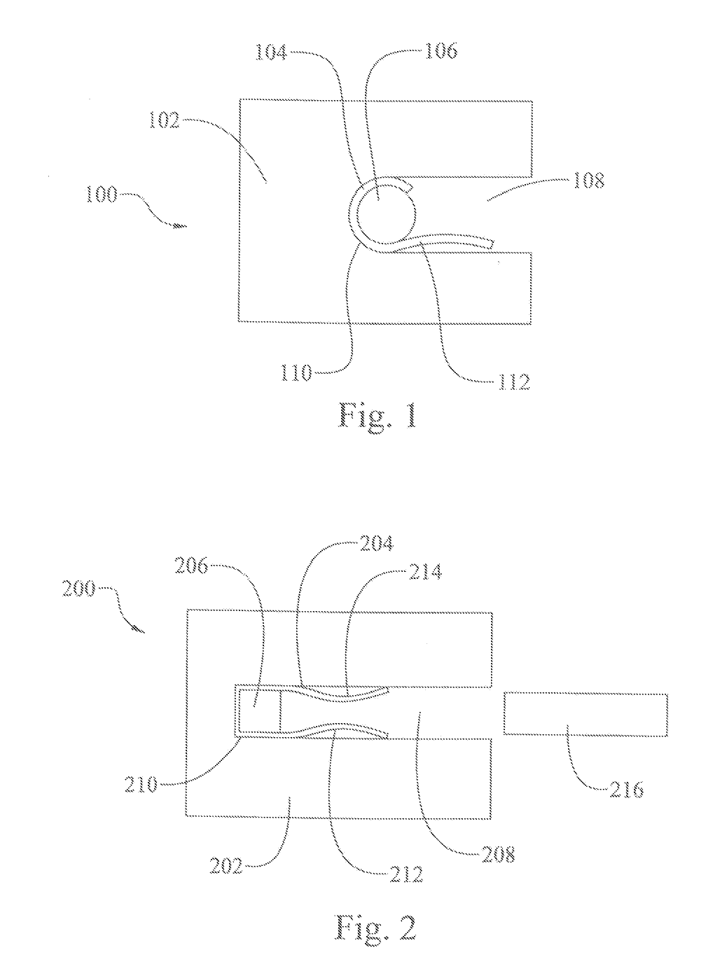

A power connector according to one embodiment of the present disclosure is illustrated in FIG. 1 and indicated generally by reference number 100. As shown in FIG. 1, the power connector 100 includes a conductive support structure 102, an electrical contact 104, and a biasing pin 106. The conductive support structure 102 defines a slot 108. The electrical contact 104 and the biasing pin 106 are positioned in the slot 108. The biasing pin 106 engages the electric contact 104 and biases a first portion 110 of the electrical contact 104 against the conductive support structure 102 to maintain electrical conductivity between the conductive support structure 102 and the electrical contact 104. A second portion 112 of the electrical contact 104 is configured to engage a bus bar when the bus bar is received in the slot 108. In this manner, good electrical conductivity can be maintained between the bus bar and the conductive support structure 102 via the electrical contact 104 and biasing pin 106.

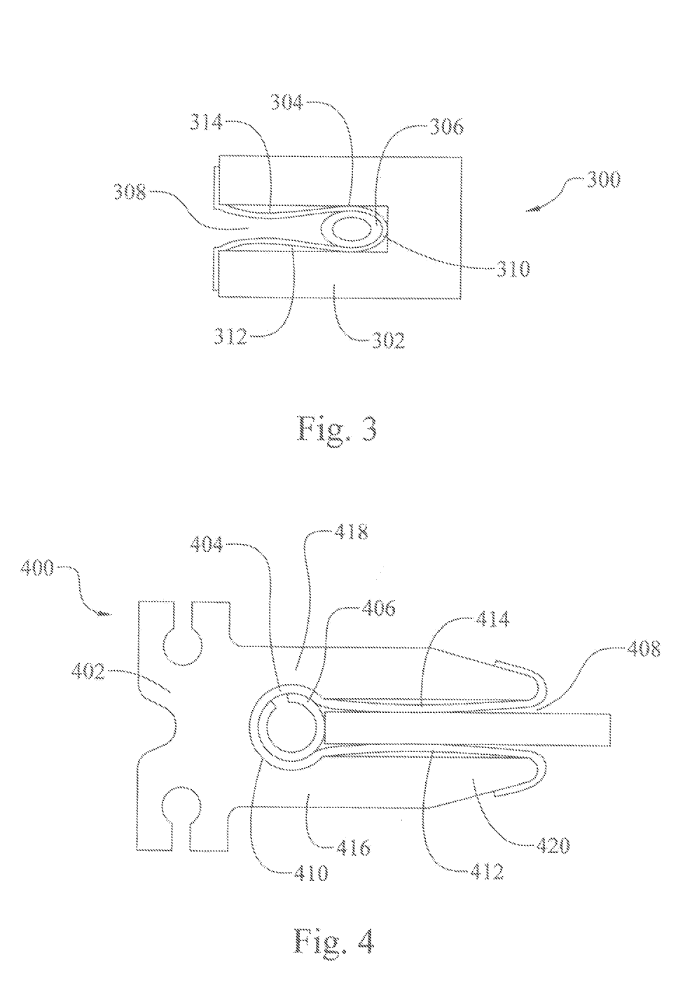

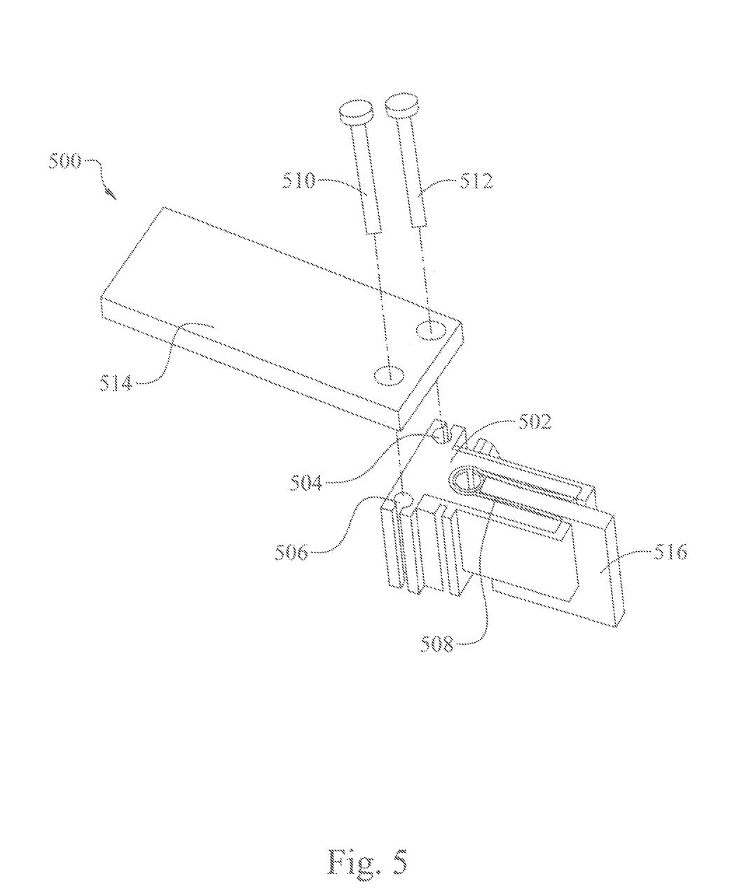

In the particular embodiment of FIG. 1, the biasing pin 106 is a solid round pin. In alternate embodiments, the biasing pin may have a different shape, size and/or fill. FIGS. 2 and 3 illustrate other examples of power connectors having biasing pins. In the power connector 200 of FIG. 2, the biasing pin 206 is a solid, rectangular pin. In the power connector 300 of FIG. 3, the biasing pin 306 is a hollow, ovular pin.

Also illustrated in FIG. 2 is a bus bar 216 not yet received within the slot 208. In the embodiment of FIG. 2, the bus bar 216 is a generally flat conductor. It should be understood, however that other types of bus bars can be employed, including, for example a hollow tube conductor, a connector pin, a contact blade, a wire terminal, etc.

Referring again to FIG. 1, the electrical contact 104 includes a second portion 112 extending away from the biasing pin 106 for engaging a bus bar. In alternate embodiments, the electrical contact may include a plurality of portions extending away from the biasing pin. For example, the electrical contact of FIG. 2 includes a second portion 212 and third portion 214 extending away from the biasing pin 206. When a bus bar 216 is received in the first slot 208, each of the second and the third portions 212, 214 will engage the bus bar. FIG. 3 illustrates another example of a power connector 300 including an electrical contact 304 having a second portion 312 and the third portion 314 extending away from the biasing pin 306. The electrical contact 304 extends beyond the first slot 308 and adjacent to external end portions of the conductive support structure 302.

FIG. 4 illustrates a high current power connector 400 according to another embodiment. As shown in FIG. 4, the power connector 400 includes a conductive support structure 402, an electrical contact 404, and a biasing pin 406. The conductive support structure 402 is the primary support structure for the power connector 400. The conductive support structure defines a slot 408 and includes a generally u-shaped portion 416. The u-shaped portion 416 has a proximal end 418 and a distal end 420. The biasing pin 406 is positioned in the proximal end 418. The biasing pin 406 biases a first portion 410 of the electrical contact 404 against the conductive support structure 402 to maintain electrical conductivity between the conductive support structure 402 and the electrical contact 404. A second portion 412 and a third portion 414 of the electrical contact 404 extend to and around the distal end of the u-shaped portion 416.

The biasing pin 406 is positioned within the slot 408 via a compression fit. In other words, the biasing pin 406 is compressed and positioned in the proximal end 418 of the u-shaped portion 416. When the biasing pin 406 decompresses in the proximal end 418, the biasing pin 406 biases the first portion 410 of the electrical contact 404 against the conductive support structure 402. In this embodiment, the biasing pin 406 is a c-lock spring pin. The c-lock spring pin 406 radially biases the electrical contact 404 against the conductive support structure 402. The constant radial biasing and complimentary shapes of the first portion 410 of the electrical contact 404 and proximal end 418 of the conductive support structure 402 allow the biasing pin 406 to create a substantial area of electrical conductivity between the electrical contact 404 and the conductive support structure 402. The substantial area of electrical conductivity between the electrical contact 404 and the conductive support structure 402 provides an electrical path with minimal resistance, power losses, and risk of overheating. In alternate embodiments, other types of biasing pins may be used to create a compression fit. For example, the biasing pin may be any one of a spring pin, roll pin, split pin, dowel pin, groove pin, or the like.

The compression fit preferably creates an airtight contact between the first portion 410 of the electrical contact 404 and the conductive support structure 402. The airtight contact prevents exposure of the contacting surfaces to air, which could otherwise result in oxidation. If the contact surfaces oxidize, the electrical conductivity between the contact surfaces is diminished by increased resistance. In some embodiments, the increased risk may necessitate the treatment of components to prevent oxidation. By providing the compression fit and preventing air exposure, the airtight contact permits the power connector to include an electrical contact and a conductive support structure free of treatment for oxidation.

The risk of oxidation may exist in embodiments in which the electrical contact or conductive support structure comprises certain materials. In FIG. 4, the electrical contact 404 comprises copper alloy, which inherently resists oxidation. In other embodiments, the electrical contact may be a different conductive material and may need treatment for oxidation in lieu of (or in addition to) an airtight contact with the bus bar or conductive support structure. In FIG. 4, the conductive support structure 402 comprises copper, a material vulnerable to oxidation. Alternatively, the conductive support member may comprise one or more other conductive metals, e.g., brass. Brass is also vulnerable to oxidation. The airtight fit of the surfaces of electrical conductivity between the electrical contact and the conductive support structure can make treatment for oxidation unnecessary.

The embodiment of FIG. 4 includes additional airtight contacts. The second and third portions 412, 414 of the electrical contact 404 comprise a resilient material, such as copper alloy. When a bus bar is received into the first slot 408, the second and third portions 412, 414 of the electrical contact 404 deform to form an airtight fit with the bus bar. Deforming the electrical contact 404 creates pressure between the electrical contact 404 and the bus bar, resulting in an airtight contact. For this reason, the bus bar may not require oxidation treatment in some application.

The biasing pin 406 in FIG. 4 comprises stainless steel. In other embodiments, the biasing pin may comprise a different conductive material, such as carbon steel. In still other embodiments, the biasing pin may comprise a non-conductive material.

As stated above, the conductive support structure 402 may comprise copper, brass and/or other conductive materials. Further, the conductive support structure may, for example, be die cast, milled made by other suitable means.

The use of a power connector generally includes several insertions (matings) and removals (un-matings) of one or more bus bars throughout its useful life. During insertion, an operator may not be in a position to fully observe the insertion of a bus bar. This is known in the art as blind mating. Blind mating may result in over-insertion of a bus bar, causing damage to the power connector. In the embodiment of FIG. 4, the biasing pin 406 acts as an insertion stop when receiving a bus bar into the high current power connector 400. The biasing pin 406 effectively prevents over-insertion of the bus bar by providing a mechanical stop. The biasing pin 406 also controls the insertion depth of the bus bar, allowing blind mating between the power connector and a bus bar at high forces. The high current power connector 400 of FIG. 4 can withstand an insertion force up to about 100N. In other embodiments, a power connector may be configured to withstand more or less insertion force as required for a given application.

During removal of the bus bar, an operator exerts force to remove the bus bar from a power connector. This force is often translated to pressure contact members within the power connector. The translated force can cause damage to the power connector or even unintended removal of the contact members along with the bus bar. As illustrated in FIG. 4, the power connector 400 minimizes such possibilities. The conductive support structure 402 defines a slot 408 wider at its proximal end 418 than at its distal end 420. In this manner, the biasing pin 406 may be wider than the slot at the distal end 420. While the bus bar 406 is being removed, a force is exerted on the electrical contact 404, pulling the electrical contact 404 and the biasing pin 406 along with the bus bar. The electrical contact 404 is “locked” into position by the width of the biasing pin 406, which cannot physically be pulled out through the distal end 420 of the conductive support structure 402 (the direction of the removal force). The high current power connector 400 of FIG. 4 can withstand a removal force up to about 100N. In other embodiments, a power connector may be configured to withstand more or less removal force as required for a given application.

During insertion, a power connector and a bus bar may be at different potentials, commonly referred to as hot-plugging the bus bar. Under this condition, an electrical arc between the power connector and the bus bar can occur. Arcing currents can cause welding, melting, deforming or burning of the contact of a power connector. The resulting contact between the power connector and the bus bar is diminished, increasing the resistance of the connection. In the high current power connector of FIG. 4, the second and third portions 412, 414 are configured such that engagement of the bus bar is “set-back” or spaced apart from the distal end 420 of the conductive support structure 402. With this configuration, the arcing during hot-plugging is generated between a bus bar and the electrical contact 404 at the distal end 420. Only minimal or no arcing occurs between a bus bar and the second and third portions 412, 414 of the electrical contact 404, which engage the bus bar. Thus, electrical conductivity between a bus bar and the contacting portions of the power connector is not diminished by arcing.

The damage caused by arcing may vary depending on the number of times a bus bar is inserted into and removed from the power connector. In addition to the force described above, a particular application may require a power connector to withstand a specified number of cycles (insertion and removal) without fault or damage to electrically conductive surfaces of the power connector. The application may also require a particular insertion and removal speed, e.g., between 13 and 200 milliseconds.

FIG. 5 illustrates an exploded view of a high current power connector 500 according to another embodiment. The high current power connector 500 includes a conductive support structure 502 defining fastener holes 504, 506 and an electrical contact 508. As illustrated, the fastener holes 504, 506 receive fasteners 510, 512 to electrically and mechanically couple an internal bus bar 514 to the conductible support structure 502. Coupling the conductive support structure 502 directly to the internal bus bar eliminates the need for a back plane. The coupling also provides a significant area of electrical conductivity between the internal bus bas 514 and the conductive support structure 502, resulting in reduced resistance. This coupling provides less resistance than the multiple solder or screw points commonly used in the prior art. In other embodiments, the conductive support structure 502 can be coupled electrically and/or mechanically to a printed circuit board (PCB). Alternatively, the fastener holes 504, 506 may be provided to couple a load to the conductive support structure 502. The fasteners 510, 512 may be screws, bolts, nails, rivets, dowels, pins, stakes, spikes, or any other suitable fastening devices.

The electrical coupling between the conductive support structure and the internal bus bar creates an electrical path between a bus bar 516, the electrical contact 508, the conductive support structure 502, and the internal bus bar 514. The resistance measured between the bus bar 516 and the internal bus bar 514 is the resistance “through the connection.” In high current applications, minimizing the resistance through the connection is essential to reduce losses and prevent overheating. The high current power connector illustrated in FIG. 5 provides an electrical path with a resistance of less than about 300 micro-ohms through the connection. In alternate embodiments including either a PCB or an internal bus bar, a high current power connector may have a resistance through the connection of less than about 200 micro-ohms.

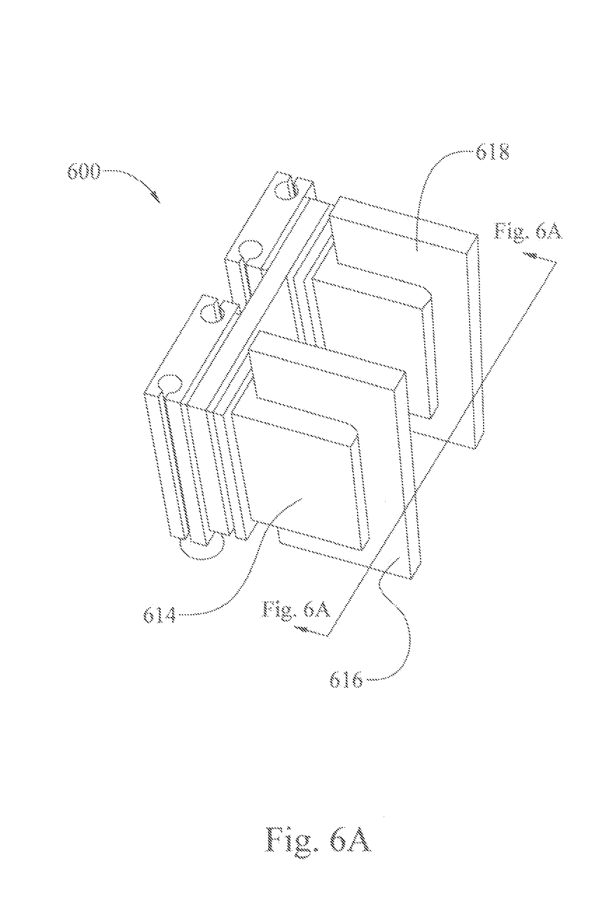

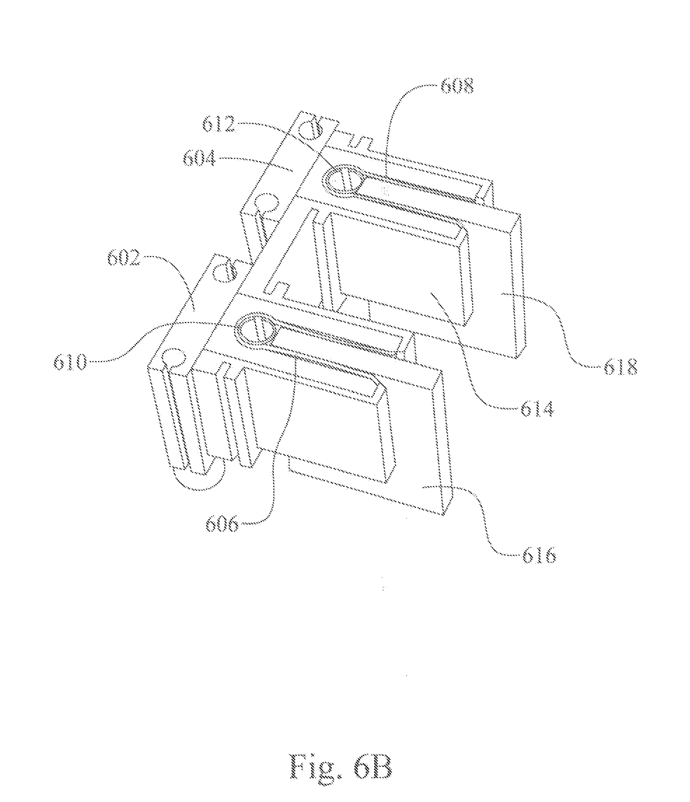

FIGS. 6A and 6B illustrate a power connector 600 according to another embodiment. As shown in FIG. 6A, the power connector includes first and second conductive support structures 602, 604, first and second electrical contacts 606, 608, and first and second biasing pins 610, 612. The power connector also includes an electrically insulative material 614. The electrically insulative material covers an external portion of the first conductive support structure and the second conductive support structure.

The electrically insulative material provides electrical isolation of the first and second conductive support structures. By this isolation, the power connector 600 can mate to two bus bars having two different potentials without shorting the bus bars. FIG. 6 illustrates an assembly of power connector 600 with a first bus bar 616 having a positive potential and a second bus bar 618 having a negative or reference potential. Alternatively, the conductive support structures may be electrically coupled to one another to further minimize resistance and provide multiple connections for a single potential. FIG. 6B is a cross-sectional view of FIG. 6A along Axis A-A.

As apparent to those skilled in the art, other embodiments may include a different number of conductive support structures, biasing pins, and electrical contacts to support several different applications. As such, a particular embodiment may be configured for the number of potentials, current and voltage ranges, and resistance requirements of the application. For example, a power connector may be configured to receive three, four or five bus bars, each at a different potential.

Although several aspects of the present invention have been described above with reference to high current power connectors, it should be understood that various aspects of the present disclosure are not limited to high current power connectors, and can be applied to a variety of other power connectors and applications.

By implementing any or all of the teachings described above, a number of benefits and advantages can be attained including improved system reliability, reduced system down time, elimination or reduction of redundant components or systems, avoiding unnecessary or premature replacement of components or systems, and a reduction in overall system and operating costs.

1. A power connector for mating with a bus bar, the connector comprising a conductive support structure defining at least a first slot, an electrical contact positioned within the first slot, and a biasing pin positioned within the first slot and engaging the electrical contact, the biasing pin biasing at least a first portion of the electrical contact against the conductive support structure to maintain electrical conductivity between the conductive support structure and the electrical contact, at least a second portion of the electrical contact engaging a bus bar when the bus bar is received in the first slot.

2. The power connector of claim 1 wherein the electrical contact includes a generally u-shaped portion having a proximal end and a distal end, and wherein the biasing pin is positioned within the proximal end of the u-shaped portion.

3. The power connector of claim 2 wherein the second portion of the electrical contact is spaced from the distal end to inhibit electrical arcing between the second portion of the electrical contact and the bus bar during hot mating of the bus bar with the power connector.

4. The power connector of claim 1 wherein the biasing pin is configured to engage a distal end of the bus bar and prevent over insertion of the bus bar when the bus bar is received in the first slot.

5. The power connector of claim 1 wherein the biasing pin is configured to provide an airtight connection between the electrical contact and the conductive support structure.

6. The power connector of claim 1 wherein the conductive support structure defines a fastener hole for mechanically and electrically coupling the conductive support structure to a power source.

7. The power connector of claim 1 further comprising an electrically insulative material covering an external portion of the conductive support structure.

8. The power connector of claim 1 wherein the biasing pin is positioned within the first slot via a compression fit.

9. The power connector of claim 8 wherein the biasing pin is a c-lock spring pin.

10. The power connector of claim 8 wherein the biasing pin is electrically conductive.

11. A power supply comprising the power connector of claim 1.

12. A high current power connector for mating with a first and a second bus bar, the connector comprising a first conductive support structure defining a first slot, a first electrical contact positioned within the first slot, the first electrical contact engaging a bus bar when the bus bar is received in the first slot, a first biasing pin positioned within the first slot and engaging the first electrical contact, the first biasing pin biasing at least a portion of the first electrical contact against the conductive support structure to maintain electrical conductivity between the first conductive support structure and the first electrical contact, a second conductive support structure defining a second slot, a second electrical contact positioned within the second slot, the second electrical contact engaging a bus bar when the bus bar is received in the second slot, a second biasing pin positioned within the second slot and engaging the second electrical contact, the second biasing pin biasing at least a portion of the second electrical contact against the conductive support structure to maintain electrical conductivity between the second conductive support structure and the second electrical contact, and an electrically insulative material covering an external portion of the first conductive support structure and the second conductive support structure.

13. A high current power connector assembly for providing power from a power source to a load, the assembly comprising a bus bar, and a high current power connector including a conductive support structure defining at least a first slot, an electrical contact positioned within the first slot, at least a first portion of the electrical contact releasably engaging the bus bar in the first slot, and a biasing pin positioned within the first slot, the biasing pin biasing at least a second portion of the electrical contact against the conductive support structure to maintain electrical conductivity between the conductive support structure and the electrical contact.

14. The power connector assembly of claim 13 wherein the first portion of the electrical contact is displaced when the bus bar is engaged in the first slot.

15. The power connector of claim 13 wherein the bus bar is free of oxidation treatment.

16. The power connector assembly of claim 13 wherein the conductive support structure defines a fastener hole for mechanically and electrically coupling the conductive support structure to one of a printed circuit board and an internal bus bar.

17. The power connector assembly of claim 13 further comprising an internal bus bar coupled to the conductive support structure, the electrical path between the bus bar and the internal bus bar having a resistance of less than about 300 micro-ohms.

18. The power connector assembly of claim 13 further comprising a printed circuit board coupled to the conductive support structure, the electrical path between the bus bar and the printed circuit board having a resistance of less than about 300 micro-ohms.

19. A method of using a power connector, the power connector including a conductive support structure defining at least a first slot, an electrical contact positioned, and a biasing pin positioned within the first slot, the biasing pin biasing at least a first portion of the electrical contact against the conductive support structure, the method comprising engaging a bus bar to the power connector by inserting the bus bar in the first slot of the conductive support structure, the bus bar displaced at least a second portion of the electrical contact.
